(19) United States
(12) Patent Application Publication
(10) Pub. No.: US 2003/0159128 A1
(43) Pub. Date: Aug. 21, 2003

(54) Generating instructions for drawing a flowchart

(76) Inventor: Thomas Kunzler, Clinton, OH (US)

Correspondence Address: STREETS & STEELE, 13831 NORTHWEST FREEWAY, SUITE 355, HOUSTON, TX, 77040, US

(21) Appl. No.: 10/079,255

(22) Filed: Feb. 20, 2002

(51) Int. Cl. G06F 9/44

(52) U.S. Cl. 717/109; 717/113

(57) ABSTRACT

A method and computer program for automatically generating flowcharting instructions from an electronic text file of a source code. The steps include identifying the branch statements in the source code, determining the branch destinations for each of the identified branch statements, storing the destinations as destination records in a data structure, and identifying a statement type for each statement. Keys for determining that statement type may be a key work, phrase, punctuation marks or other symbols contained within each source code statement. The method is applied to source code statements written in any computer programming language. The instructions may then be imported into a drawing program where the flowchart may be drawn or viewed. The method may also be applied in reverse, automatically generating an electronic text file of a source code from a flowchart of a computer program.

### BACKGROUND OF THE INVENTION

1. Field of the Invention

The present invention relates to the field of computer software and more particularly to the field of computer software for generating flowcharts.

2. Description of the Related Art

Computers are a mainstay of today's business and technology world. Almost all businesses have some level of computerization that solves problems and runs routine tasks for the business. Many businesses, especially large businesses, have computer programs that were written to address the specific business needs of those businesses. Many businesses have computer programmers that write such programs and, as business needs change over the years, these programmers are instructed to alter the computer programs so that the computers will manipulate data in a different way than before in order to better help the business achieve its goals.

When a computer program is written, the programmer generally first creates a flowchart that shows the steps that the computer program will perform. Then, using the flowchart, the source code for the computer program is written by the computer programmer. The flowchart illustrates the steps that the program takes in an easy to read diagram. Most people find it much easier to read a flowchart for a program than to try to read the source code. The source code is written in a language that can, after some processing and translating, be read and executed by a computer. The source code may be written in such languages as, for example, COBOL, FORTRAN, C CODE or in proprietary languages installed on computers for specific uses such as in the process control industry.

A problem faced by many businesses is that after a computer programmer changes the source code to meet the new needs of the business, the flowcharts are not always updated, thereby resulting in incomplete documentation of the instructions actually being executed by the computer. This lack of documentation, coupled with the turnover of computer programming personnel, may result in programs running on computers with no one knowing exactly what instructions the computers are actually performing.

The above scenario is especially critical when the computer is running a program that is used to control a process in the process industries, such as the paper, chemical or oil refining industries. In these industries, a process may be computer controlled, and the computer will attempt to run the process as efficiently as possible. When a company decides to upgrade a process, often the business will find that the documentation of changes made to the computer program on the run have not been adequately documented. Therefore, it becomes necessary to hire someone to study a printout of the source code from the computer, and then draw a flowchart of the source code. This is a very costly and time consuming process but often a necessary one.

What is needed is a method that can provide a business with a flowchart of the source code of a computer program running on the business's computer without having to have it drawn out by hand by a person who is reading the source code. It would be an advantage if the procedure could examine the source code itself without requiring translation by a person where transcription errors or misunderstanding of code may introduce inaccuracies to the documentation.

### SUMMARY OF THE INVENTION

The present invention provides a method and a computer program for automatically generating flowcharting instructions from a source code. The method provides loading source code statements into statement records of a data structure, wherein each statement record contains only one of the source code statements, identifying each branch statement contained in the statement records, determining one or more branch destinations for each of the branch statements, storing the one or more branch destinations in one or more destination records of the data structure, wherein the one or more destination records correspond to the statement record of the branch statement, and identifying a statement type for each statement contained in the statement records. The method may be applied to source code statements written in any computer programming language including, but not limited to, FORTRAN, COBOL, PASCAL, PERL, Visual Basic and C/C⁺⁺.

A record management system of statement conventions is maintained, the record management system comprising defined branch statement records and alternative branch statement records, wherein each alternative branch statement record is associated with one defined branch statement record. The record management system of statement conventions is selected from a database, a spreadsheet, an array, a set of coded rules in an applications program and combinations thereof. The method may further comprise finding any alternative branch statements in the statement records and replacing each of the found alternative branch statements with the associated defined branch statement.

A record management system of statement classifications may be maintained comprising, for each source code statement type, a statement key, a statement format, a destination location, branch connector labels, a flowchart shape, and combinations thereof. The statement key comprises a word, a phrase, punctuation marks, other symbols, and combinations thereof. Statement types may be selected from executable statements, non-executable statements, comment statements and combinations thereof. Statement types may be selected from decision, input, output, comment, computational, arithmetic, data, type, logic, start, loop, transfer and end. Statement types may be selected from chain statements and branch statements. The record management system of statement classifications is selected from a database, a spreadsheet, an array, a set of coded rules in an applications program and combinations thereof.

The step of identifying a statement type for each of the source code statements contained in the statement records further comprises matching a statement key with each of the source code statements, wherein the statement key is associated with one statement type, and wherein the statement key comprises a word, a phrase, punctuation marks, other symbols and combinations thereof; and recording in the data structure the statement type for each statement in the statement records. Additionally, the method further comprises assigning a flowchart shape to each statement of the source code, wherein each flowchart shape is associated with the statement type of each statement of the source code and storing the assigned flowchart shape in a shape record in the data structure corresponding to the statement record.

The data structure used in the method may be contained in any program that manages records. The data structure may be selected from a spreadsheet, a database, a linked list, an array or combinations thereof. The data structure may be created in a computer language selected from COBOL, C, PASCAL, and C/C++.

The step of loading source code statements into statement records of a data structure further comprises assigning a unique statement number corresponding to each statement record, and storing the unique statement number as a unique statement number record in the data structure.

The step of determining one or more branch destinations further comprises parsing each identified branch statement to find the one or more branch destinations designated within the branch statement, and recording the one or more branch destinations into one or more branch destination records contained within the data structure, wherein each of the branch destination records are associated with the identified branch statement record.

The method further comprises exporting the data structure into a drawing program, wherein the data structure contains statement records, statement number records, destination records, branch label records, and shape records, laying out shapes as defined in the shape records, inserting text from the statement records into the shapes, linking the shapes from the destination records, sizing the shapes and fonts so that the shape is large enough to neatly accommodate the text, and displaying the flowchart.

The present invention further provides a method and a computer program for generating a source code text file from a flowchart comprising: assigning a shape name to each shape appearing on the flowchart, wherein the shape name is a statement number assigned to a first statement within the shape, and wherein each shape name is less than all subsequent shape names; ending each source code statement within each of the shapes with a statement end character; writing the statements contained within each shape to an ordered array with the associated shape names; ordering the array from the least shape name to the highest shape name; and writing each line of the ordered array to a text file.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic diagram of an exemplary computer system on which the present invention may be implemented.

FIGS. 2A-2B are exemplary spreadsheets generated by implementing the present invention.

FIG. 3 is an exemplary flowchart generated by implementing the present invention.

FIG. 4 is an exemplary portion of a statement classification database.

FIG. 5 is an exemplary portion of a statement convention database.

FIG. 6A-6B is a flowchart for a method of generating a spreadsheet containing information required to generate a flowchart of a source code.

FIG. 7 is a flowchart of a method for generating a flowchart from the information contained in the spreadsheet generated by the method of FIG. 6.

### DETAILED DESCRIPTION

The present invention provides a method and applications computer program for generating flowchart instructions from an electronic text file of a source code. The steps include identifying the branch statements in the source code, determining the branch destinations for each of the identified branch statements, storing the destinations as destination records in a data structure, and identifying a statement type for each statement. The method will generate a flowchart for a source code of any computer language, such as, for example, FORTRAN, COBOL, Basic, C/C++, PERL as well as proprietary computer languages that may be found, for example, in computer control applications in the process industry. While this section includes examples of the FORTRAN programming language, these examples are presented merely to enhance the discussion and are not meant to limit the invention to any one programming language.

The source code is a computer program written by a computer programmer that includes a set of instructions for a computer to execute. The programmer writes the source code in a particular computer language of the programmer's choice. Factors that may influence the computer language chosen by the programmer include, for example, the application for the computer program, the hardware and system on which the program will be executed and the knowledge of the computer programmer. A compiler or assembler may then convert or translate the source code into machine language, a language that the computer understands.

A computer normally executes the instructions contained in the source code in the order that the instructions appear in the source code. Therefore, a flowchart of the source code may merely be a listing of the statements making up the source code, each statement contained within a box, with each box connected by an arrow to the box following it. However, there are some statements in the source code that instruct the computer to branch to a statement other than the statement that follows directly. This statement type, called a branch statement, makes the automatic generation of a flowchart for a source code more difficult than merely listing the statements in the order they appear in the source code. A branch statement is often a decision statement that, based upon the outcome of the decision, directs the computer to one of two or more different possible destinations. For example, a simple branch statement might be: IF (x.GT.6) GO TO 100. Basically, this statement may instruct a computer to 5 check the value of the variable x, if the value is greater than 6, then continue to the next statement and execute the instructions there. Alternatively, if the value of x is not greater than 6, then continue by executing the statement labeled 100.

Therefore, to generate a flowchart of a source code, it is most important to be able to locate and identify the branch statements, because the branch statements are the most difficult to flowchart. Each branch statement may be identified by the use of a statement key, which is a key word, phrase, punctuation mark or symbols contained in the branch statement. For example, in the computer language FORTRAN, a branch statement may include, for example, GO TO or IF. The language is constructed in such a way that if a statement in the source code contains the word IF or the phrase GO TO, then the statement is a branch statement. Each of these key words, phrases, or other symbols or punctuation used in branch statements may be stored in a statement classification database, other record management system for storing data, or as coded rules in an application program, providing identification of all the possible branch phrases, words, punctuation or symbols for a particular computer language. By searching each line in the source code for the statement keys contained in the statement classification database, contained in the application program itself as coded rules, contained in any other statement classification data structure, or combinations thereof, each branch statement may be identified.

After a branch statement is identified, the branch destinations must be identified. For each of the different types of branch statements, for example, the GO TO or IF statements previously discussed, each computer language has a defined format for writing the destinations of the branch. The formats for writing the branch destinations are also stored in the statement classification database, other record management system, as coded rules in an application program, or combinations thereof, correlated with the particular type of branch statement to which the format applies. Thus, when a branch statement is detected, the destinations of the branches may be determined, based upon the formatting of a word, phrase, symbol, symbols or punctuation marks contained within the statement, as revealed in the statement classification database, other data management system, within the applications program itself as coded rules, or as combinations thereof.

Furthermore, there also may be text associated with the branch statement and revealed in the formatting stored in the statement classification database or in the coded rules, as a branch label. For example, the decision a computer makes in a particular branch statement may be answered as, for example, yes or no, else, else if, true or false, greater than, equal to, or less than. If the answer to a decision made in a particular branch statement is yes, the computer will branch as instructed to one location. If the answer is no, the computer will branch as instructed to another location. The branch destination may be anywhere in the source code, including the next statement after the branch statement. These branch texts, when associated with a branch destination, must be noted so they may be added to the flowchart as branch labels on the connecting lines for each of the different branches.

Source code may contain several different statement types. Some statements in the source code instruct the computer to perform a calculation or to make a decision. Other statements instruct the computer to communicate with another device. Still other statements may simply define variables. The computer programmer may also add comments to the source code to help a person reading a printout better understand the method of the computer program. The computer, however, ignores comment statements.

Statements in the source code may be classified as executable statements or non-executable statements. Non-executable statements are statements that, for example, set up a program's arrays, define the variables, provide formatting and generally allow the computer to set itself up to execute the program instructions. In FORTRAN, examples of non-executable statements are FORMAT, DATA, DIMENSION and type statements. Executable statements on the other hand, are all the other statements that the computer executes whenever a computer program runs. These executable statements will appear on a flowchart as either chain statements or branch statements. Branch statements send the computer to different locations within the source code, usually depending on the outcome of an equation contained within the branch statements. A branch statement always has more than one possible destination for the computer to go to execute the next instruction. Chain statements, or straight chain statements, only have one destination for the computer to go to after the computer has executed the chain statement, and that destination is always the statement that directly follows in the program. Comment statements, as mentioned earlier, merely provide comments from the computer programmer to a person reading the source code and are ignored by the computer running the program. They are therefore considered to be neither executable nor non-executable statements.

Each statement type should appear on the flowchart inside of a particular designated shape as dictated by common flowcharting standards. For example, a decision statement may normally appear inside of a diamond shaped box. Chain statements may be grouped together inside one rectangular box, or a single chain statement may be contained within a single rectangular box. Likewise, non-executable statements may all be grouped together within one rectangular box or a single non-executable statement may be contained within a single rectangular box. Alternatively, non-executable statements of the same type may be placed together within a single box on the flowchart. Statement types contained within a unique shape on a flowchart may include, for example, a decision statement, the starting and ending statements of a program, computational statements, and input and output statements. Each statement type stored in the statement classification database, other record management system, within the applications program itself as coded rules, or combinations thereof, is associated therein with a particular shape in which the statement will appear on the flowchart.

Each statement in the source code must therefore be identified by its statement type and assigned the shape associated with the identified statement type. Examining the statement keys, those key words, phrases, punctuation or other symbols contained in the statement, and matching these key words, phrases, punctuation or other symbols to the statement keys contained within the statement classification database, other record management system, or as coded rules within the applications program itself, identifies a statement's type and assigns a corresponding shape that the statement should appear within on the flowchart.

It should be recognized that there are different “dialects” of computer languages used by a computer programmer to write a source code. One computer programmer may write a statement in one way and another computer programmer may write the statement in a different way. For example, one programmer may write GO TO and another may write GOTO. The compiler will recognize both and treat each statement the same way when the compiler translates the source code to machine language. However, to minimize the number of statements contained within the statement classification database of the present method, the present method defines a convention or group of conventions for writing each statement type and these “defined” conventions are the statements listed in the statement convention database, other record management system, or as coded rules in an applications program. All other ways of writing a statement are “alternative” statements. These alternative statements are also stored in the statement convention database, other type of record system, or as coded rules in an application program in a manner that associates the alternative statements to a defined statement. Use of the statement convention database or the coded rules in an applications program allows the method to force all the source code statements to conform to the defined convention before the source code is searched to identify branch statements and other types of statements. The method may then search the statement classification database, other record management system, or the rules in an application program for fewer words, symbols or punctuation to identify and classify the statements, or to identify the destinations of the branch statements.

Furthermore, by converting the statements to a defined statement convention, the resulting flow chart may be more effective. For example, the statement IF (RCODE .NE. 0) X=Y is an alternative to the three separate defined statements as follows: IF (RCODE .NE. 0) THEN; X=Y; END IF, where each of these statements that are separated by a semi colon would appear as a separate line of code in FORTRAN, without the semi colon. Therefore, the one line shorthand statement written by a computer programmer may be converted to the long hand version, having three separate statements appearing as three separate lines of code, that will make the flowchart easier to read. This change from the shorthand statement of the above example is particularly important when, for example, the statement is nested within other IF statements and it becomes necessary to determine the range of each nested statement by matching IF statements with END IF, ELSE IF and ELSE statements and depending on the source code language, the brackets, continuation statement, semicolons and other punctuation used to link the beginnings and endings of branched statements.

Nested statements, such as nested DO loops or nested IF statements, present a particular problem for a method of generating a flowchart. Nested loops execute a set number of statements which themselves are part of another set number of statements comprising a loop. The situation is quite analogous to several algebraic statements contained within different sets of parentheses, with one set of parentheses contained inside another set of parentheses, contained within another set of parentheses, and so forth. The first open parentheses must correspond with the last close parentheses. The second open parentheses must correspond with the next to last close parentheses, and so forth. Therefore, the method first locates the first end of loop/conditional statement, which may be a word, phrase, punctuation or symbol depending on the computer language being used, such as the phrase END IF. Then the method finds the first IF statement immediately preceding the END IF. This matched pair of IF and END IF statements comprise the first nested loop. The method then finds the next end of loop conditional statement and works backwards to find the IF statement immediately preceding the last IF statement it found. These IF and END IF statements would then be associated. The method would continue until all of the IF statements and END IF statements were matched up. While the example is for an IF statement, the method is applied to all statement types that are capable of being nested and in any source code language.

An additional problem with nesting occurs in a shorthand IF statement format having the conditional contained within nested sets of parentheses. A shorthand IF statement format is IF (conditional) (resultant), wherein the conditional may have several sets of conditionals, each contained within a set of parentheses. This format may be re-written in the long or defined format by defining rules that “balance parentheses” so that the conditional parentheses may be separated from the resultant parentheses.

As will be apparent to those having ordinary skill in the art, an application program may gather all the information as discussed above and enter the information into a record management system. The record management system may be, for example, a spreadsheet, a database, an array, a linked list or a combination thereof. Using a spreadsheet as an example, an applications program may load the source code into the spreadsheet from an electronic text file or other source. Each statement of the source code is contained on one row of the spreadsheet and a unique number is assigned to each statement, each assigned number entered into the spread sheet on the same row as the associated statement but in a different column. It should be noted that, if a statement is an unusually long statement, that statement may be written on several lines in the source code text file, yet that statement is still a single statement. A continuation mark, such as a character in column 6 in a FORTRAN source code, may be used to indicate that the previous statement continues into the statement having a character in column 6. In some other source code languages, a statement does not end until a semi colon is inserted. Therefore, each line of the source code must be examined for continuation marks or for statement end characters, so that each statement of code is clearly identified and each statement of code occupies one row in the spreadsheet. Each statement may then be examined and compared to the statements contained in the statement convention database, other record management system, as coded rules within the applications program itself, or as combinations thereof, and re-written or forced from an alternative format to a defined convention format. If additional statements are added in re-writing an alternative statement to a defined convention statement, then the statement numbers assigned to each statement are adjusted as necessary.

Each source code statement in the spreadsheet is compared to the statement keys, those key words, phrases, punctuation marks or other symbols contained within the statement classification database, other record management system, as coded rules in the applications program itself, or combinations thereof. The statement classification is determined by matching words, phrases, punctuation or other symbols of the source code statement with the statement keys for the different types of statements. The statement classification for each statement is recorded in the spreadsheet associated with the assigned unique statement number and the associated shape in which the statement will appear on the flowchart. In the same manner, branch destinations and associated branch text labels are identified and then recorded in the spreadsheet associated with the assigned unique statement number.

Determining the destinations of each branch statement is accomplished by parsing each statement of the source code. For example, consider a FORTRAN source code statement IF (X-Y) 10, 20, 30. First, the applications program would match the word IF from the source code statement with the key word IF in the statement classification database or with the rules coded in the applications program itself, thereby determining that the statement is an IF statement. Recognizing the statement as an IF statement then focuses the applications program on the different types and formats for IF statements. The application program may check inside the parentheses to determine whether the equation within the parentheses is an arithmetic or logic equation. By determining that the equation is an arithmetic equation, the application program knows that the statement is an arithmetic IF statement. Alternatively, it may be determined that the IF statement is an arithmetic IF by recognizing that there are three numbers at the end of the statement, each separated by a comma.

Now focusing on arithmetic IF statements, the application program proceeds, with rules coded in the applications program, or by comparison with the statement type data structure, under the rule that all arithmetic IF statements always have three destinations after the close parenthesis, each separated by a comma. The first destination will be used if the arithmetic statement is negative, the second destination will be used if the arithmetic statement is zero, and the third destination will be used if the arithmetic statement is positive. As the applications program continues to parse the statement, the applications program may find the close parentheses, and then record the first number after the close parentheses as the first destination, the number after the first comma as the second destination, and the number after the second comma as the third destination. The applications program ignores everything else in the statement, such as spaces or the equation inside the set of parentheses, as the applications program parses the statement. The destinations and the associated branch labels that will appear on the connecting lines to each of the three different destinations are recorded by the applications program in the spreadsheet associated with the unique statement number assigned to the analyzed statement. The next statement in the source code is then parsed in a similar manner until all the source code statements have been analyzed.

Preferably, each statement is first searched for a statement key that identifies the statement type. Then, if the statement type has been identified as a branch statement, a subroutine or macro written for that particular identified branch statement type may be called to parse the statement. The statement may be parsed by the rules that have been coded into the subroutine or macro, to determine the branch destinations. Only statements that have been identified as branch statements are parsed to determine their branch destinations.

The method of the present invention provides a straightforward method for providing instructions to generate a flowchart of a source code. The executable statements in the flowchart appear exactly in the same order as the executable statements appear in the source code, except that some statements may be re-written to a defined statement format and branch destinations are determined and shown. Statements are not analyzed for content, other than to identify branch statements and then to identify the branch destinations, and to identify statement type so that a proper shape may be used to display the statements on the flowchart. In this manner, instructions for drawing a complete flowchart of a source code may be quickly and easily generated. Advantageously, the information needed about a particular source code language is limited only to the information required to identify the type of each statement in the source code and to identify the branch destinations for branch statements.

The present method provides a spreadsheet, or other record management system, containing all the information needed for a drawing program to proceed with the generation of a flowchart of the source code. The spreadsheet may be exported to a drawing program such as VISIO 2000, a computer program product and registered trademark of Microsoft, Inc., Seattle, Wash.. Any drawing system would be suitable so long as it is capable of importing the information contained within the spreadsheet or other record management system and converting that information into a flowchart.

After the spreadsheet or other record management system is imported into a drawing program, such as VISIO®, macros written in the drawing program, within the knowledge of those having ordinary skill in the art, may first lay out each designated shape in the order listed on the spreadsheet, connect each non-branch shape to the next shape with an arrow, connect and label branches from each branch shape to locations as directed in the spreadsheet, copy the source code statements from the spreadsheet into the shapes, and size the shapes and text to generate a high quality flow sheet.

The present method may also be used in the reverse to generate a source code from a flowchart prepared by a computer programmer. A computer programmer may also make changes to a flowchart generated by the present method and then, running the method in the reverse, generate the source code for the computer from the revised flowchart. For example, new statements may be added within new shapes, existing statements may be changed or edited, statements may be located to new positions within the flowchart, and/or new statements may be added within existing shapes.

If a new shape is added, the new shape is connected to the shape on the flowchart associated with the statement before the statement contained within the new shape. The new shape is also connected to the shape or shapes containing the next statement to be executed after the computer executes the statement contained within the new shape. If the new statement is a chain statement, the only destination will be the next statement. If the new statement is a branch statement, then the destinations will be the branch destinations of that branch statement.

When the flowchart is generated from the spreadsheet or other data structure imported into the drawing program, each shape on the flowchart is assigned, as a shape name, the statement number appearing within the shape. When a new shape is added, the new shape is assigned a name that designates the location of the new shape, and thereby the new statement, in the source program, i.e., a letter appended to the preceding statement number. For example, if a new shape is added after shape 10, the new shape becomes shape 10A and the statements within the new shape become statement numbers 10A.

Changes may be made to the statements within the shapes. Existing shapes may be relocated to new positions within the flowchart. When a shape location is changed, the new position is treated like the addition of a new shape discussed above.

Since a shape may contain more than one statement, the statement number assigned the shape is the first statement number that appears in the shape. To have all the other statements appear in the same shape, the statements are all assigned the same statement number within the data structure containing the instructions for the drawing program. The other statements contained within the shape all have the same number. To designate the end of each statement within the shape, a special end statement character may be used, such as, for example, an underline at the end of each statement.

Next, the text within each shape is written to an ordered two-dimensional array with the associated statement number, which is the shape name. The array is then sorted by the associated statement number. Next, the sorted array is printed to a text file, without the statement numbers. If multiple source code statements are contained within one shape on the flowchart, the end statement character, which may be the underline character, is recognized when being printed to the text file. When the end statement character is recognized, the end statement character is removed and the next statement is written to a new line in the text file. The statements in the source code text file appear in the same order as the statements appeared on the flowchart. Since the branch destinations are contained within the statements, the method for writing to the text file would not have to be concerned about determining branch destinations. Source code rules are followed, such as starting all statements in column 7 or after for FORTRAN.

If writing a program from scratch on a flowchart, the flowchart may be converted to a text file of the source code using the rules discussed above. Each shape on the flowchart is assigned a name, which is the same as the statement numbers contained therein.

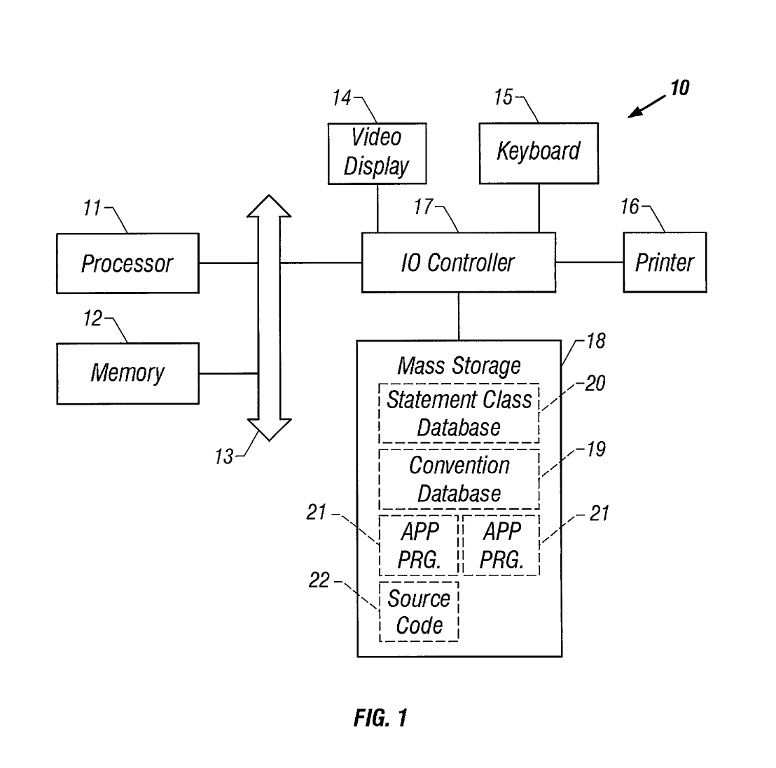

FIG. 1 is a schematic diagram of an exemplary computer system on which the present invention may be implemented. The system 10 includes conventional components such as a processor 11, memory 12 (e.g. RAM), a bus 13 that couples the processor 11 and memory 12, a mass storage device 18 (e.g., a magnetic hard drive or an optical storage disk) coupled to the processor 11 and memory 12 through an I/O controller 17. Operator access is available through a video display 14, keyboard 15 and printer 16, each attached to the I/O controller 17. It will be appreciated from the description below that the present invention may be implemented in application software 21 that is stored as executable instructions on a computer readable medium on the system, such as mass storage device 18 or in memory 12. Also stored on the mass storage device 18 is the statement convention database 19, statement classification database 20 and an electronic text file of the source code 22.

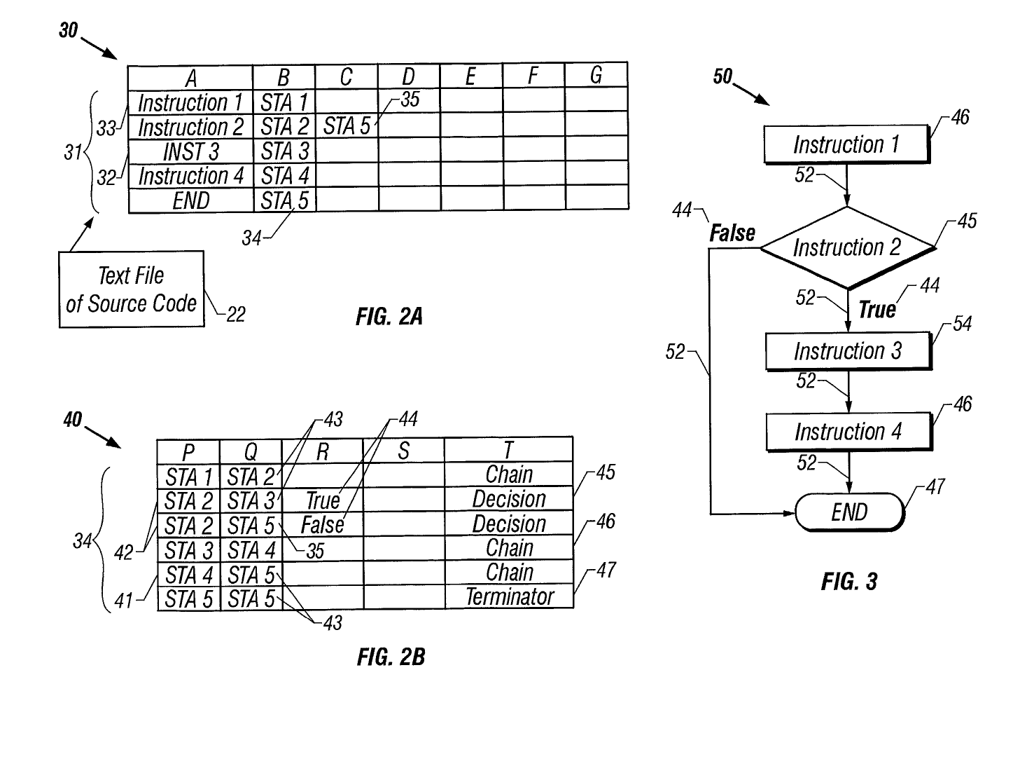

FIG. 2A-2B are exemplary spreadsheets generated by implementing the present invention. In FIG. 2A, an electronic text file 22 of the source code which is to be flowcharted is imported into column A of the spreadsheet 30, each of the statements 31 of the source code being assigned a separate row in the spread sheet 30. Each of the source code statements represents a separate instruction for the computer to execute or is a non-executable statement. While the computer programmer wrote most of the instructions in a conventional manner, shown as, for example, Instruction 1 33, the computer programmer wrote Inst. 3 32 in an alternate shortcut or abbreviated format. All the statements 31 are assigned unique statement numbers 34 listed in column B of the spreadsheet 30. As branching destinations are determined, branching destinations 35 are listed in columns C through G as needed. While in this example the branching columns are C through G, this is not meant to be limiting and may be as many columns as needed for the number of branches in a statement.

In FIG. 2B, a spreadsheet 40 lists each statement number 34 in column P as assigned in column B of FIG. 2A. Column Q lists the destination of the statement shown in column P. If the statement is not a branching statement, then the destination is simply the next statement 43. If a statement is a branching statement, as shown in STA2 42, then each branch destination 35, 43 is separately recorded in separate rows. In column R, recorded with each branching statement, is any text or branch label 44 that is to be associated with the branch destination so that the text may appear as a label on the connecting line appearing on the flowchart. Column T identifies the shape in which the statement appearing in column P will appear on the flowchart. For example, these shapes may be a chain shape 46, a decision shape 45 or a terminator shape 47.

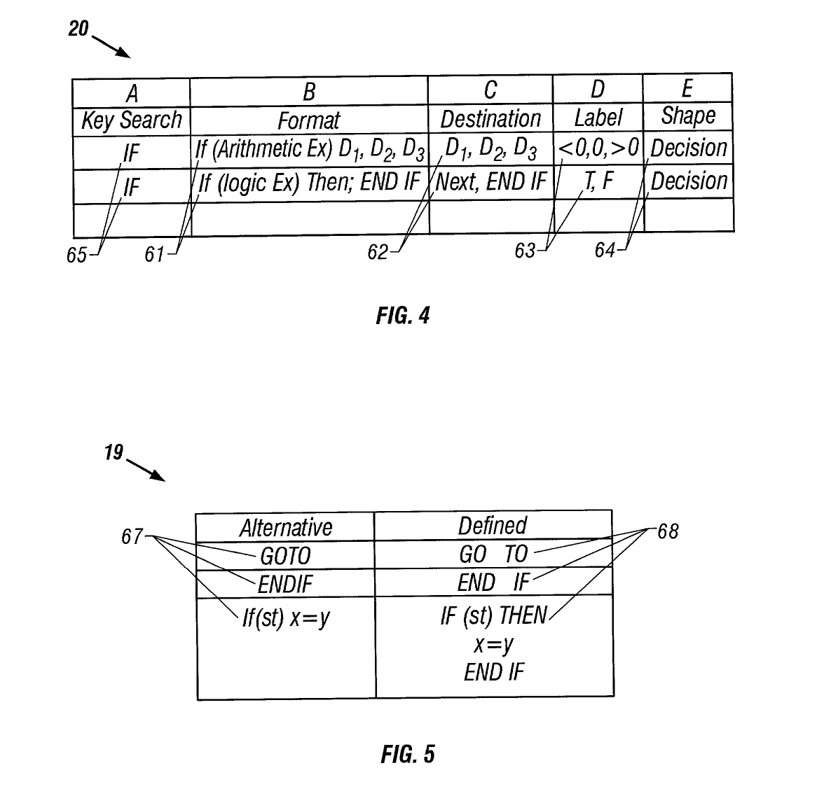

The statement types are shown in the statement classification database 20, of which an example portion is shown in FIG. 4. For each statement type, the statement classification database includes, for example, the statement key, which is the key word, phrase, punctuation or other symbols that identify the statement type, the statement format, the destinations to which the computer may go after processing the statement, any flowchart branch labels that may be associated with the branch destination and may appear on the connection line between two shapes, and the shape in which the statement will appear on the flowchart. By comparing the words or symbols that appear in each source code statement with the statement keys 65 recorded in the classification database, the statement type may be determined. For example, when the word “IF” is found in a source code statement, comparison with the statement keys 65 determines that the statement is an IF statement. Column B of the statement classification database 20 shows all the different possible formats 61 for IF statements that may exist. Parsing the source code statement and comparing the source code statement with the different possible formats 61 matches the source code IF statement with a particular format contained within the statement classification database. For a given format, the branch destinations 62 may be determined along with the associated connection line branch label 63. The shape 64 that will appear on the flowchart for the given statement type is also contained in the database as listed in column E.

FIG. 3 is an exemplary flowchart generated by implementing the present invention. The flowchart 50 is generated from the information contained within the spreadsheets of FIGS. 2A and 2B. Each instruction appears within a shape 45, 46, 47 as defined in column T of FIG. 2B. The connecting lines 52 are drawn from the location shown in column P to the location shown in column Q of FIG. 2B. The appropriate branch label 44 is written on the connecting lines 52 from the decision shape 45. The corrected defined statement is shown on the flowchart as Instruction 3 54 rather than the abbreviated alternative, Inst. 3 32 as shown in FIG. 2A.

FIG. 5 illustrates a portion of the statement convention database 19, which lists the different alternative formats for source code statements that are re-written by the method to conform these alternative formats to the defined source code statements shown in the statement convention database 19. The statement convention database lists all the possible alternative formats 67 for a statement and the associated defined statement 68. Rules, or instructions, for identifying and converting the alternative formats may be coded into an applications program. For example, it may be straightforward to identify GOTO and then replace it with GO TO. To convert the IF statement to the defined statement 68, is more complex. First, after identifying the statement as an IF statement, the inquiry might be whether the statement ends in THEN? If not, is a continuation mark present? This form of inquiry, as those with ordinary skill in the art will recognize, may be continued until the alternative form is identified, and then an instruction may be implemented to replace the alternate format 67 with the defined format 68. These instructions may be coded into the applications program, preferably as a macro or sub-routine.

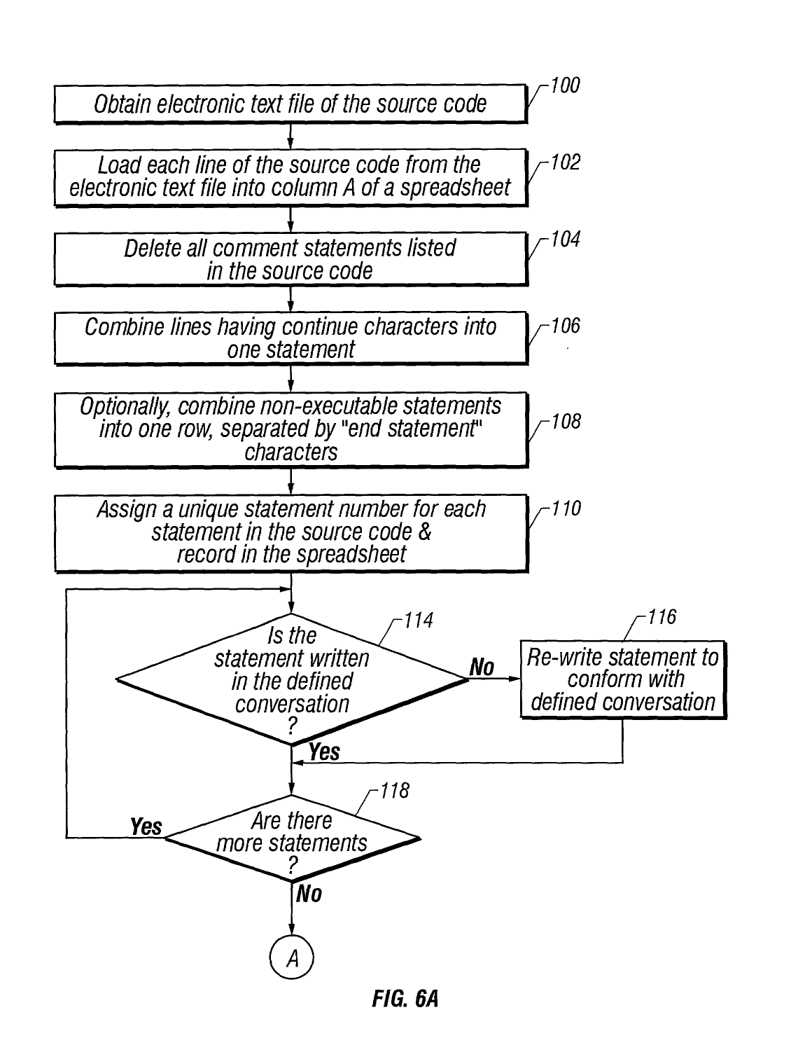

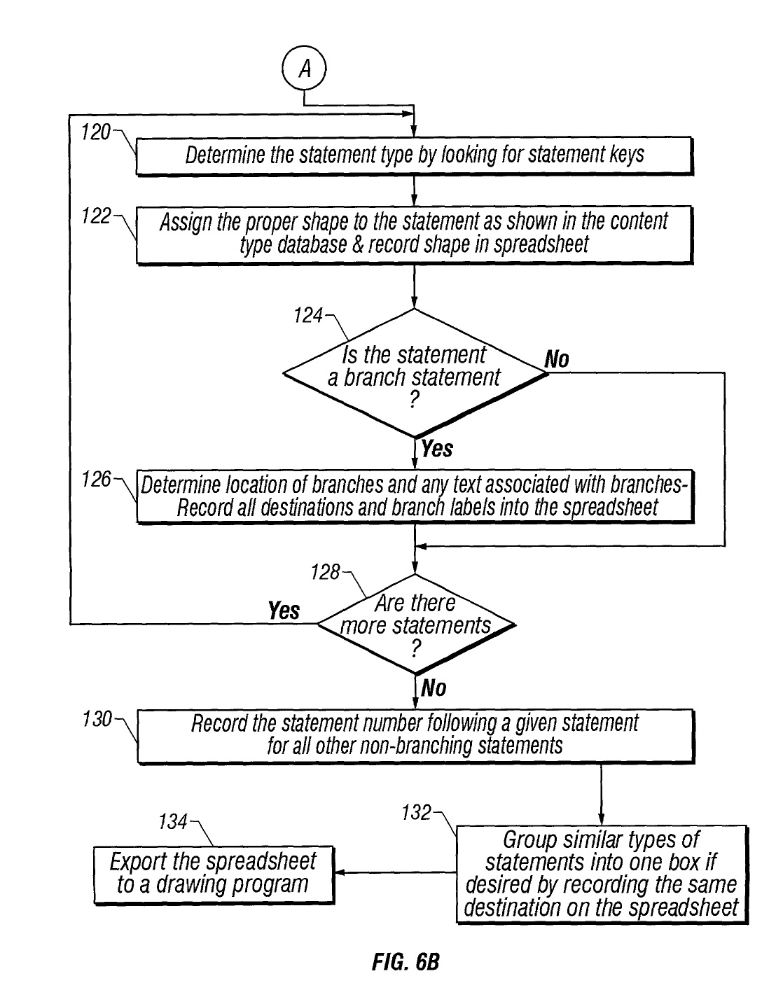

FIGS. 6A-6B are a flowchart for a method of generating a spreadsheet containing information required to generate a flowchart of a source code. In state 100, an electronic text file of the source code to be flow-charted is obtained. In state 102, the source code from the electronic text file is loaded into the spreadsheet's column A, with each line or statement of the source code being loaded into a separate row in the spread sheet. Because comments contained in the source code are not normally shown on a flowchart, in state 104, each comment line is deleted from the spreadsheet. Alternatively, the comments could be included in the flowchart and inserted following the statement just before the comment line in the source code or inserted as a group at the end of the flowchart.

After all the source code statements from the electronic text file are loaded into the spreadsheet, then in state 106, statements having a “continue” character are combined into the same spreadsheet row so that the whole source code statement is contained in one row of the spreadsheet. For example, if one row shows a character in column 6, thereby designating that line to be a continuation line from the preceding line, then that line is added to the end of the preceding line to make a complete source code statement in the preceding row. Optionally, in state 108, non-executable statements, such as assignment or variable statements, may be combined onto one row, separated by a character to designate the end of a statement, so that these statements may appear in one common shape on the flowchart. In state 110, a unique statement number is assigned to each statement and recorded in column B of the spreadsheet in the same row as the corresponding statement in column A, thereby associating a unique number with each statement of source code. In state 114, each statement in column A is compared with the defined convention wording, contained in the convention database or as coded rules in the application program, to determine if the word, phrases, punctuation, or symbols are written in the defined convention. If, in state 114, the statement is not in the defined convention format, then in state 116, the statement is rewritten in the defined convention format. If, in state 114, the statement is in the defined convention, or after the statement has been re-written in state 116, then the method determines if there are any further statements to check. If, in state 118, there are further statements to check, then the method returns to state 114 as discussed above. If, in state 118, there are no other statements to check, referring now to FIG. 3B, then in state 120, each statement is identified as to statement type by comparing the word, phrases, punctuation or symbols contained in the statement with the statement keys contained in the statement classification database or contained as coded rules within the applications program.

In state 122, the designated shape associated with the identified statement type is recorded in the spreadsheet in such a way as to be associated with the assigned unique statement number. For example, the designated shape may be recorded in a different column of the same row as the associated statement number. The designated shape and a given statement type are associated with each other in the statement classification database or in coded rules within the application program. If in state 124, the statement is a branch statement, then in state 126, comparing the word, phrase, punctuation or symbols contained in the statement with those contained in the statement classification database or as coded rules in the application program, each branch destination and related branch label is determined and entered into the spreadsheet in separate columns associated with the statement's spreadsheet row. If, in statement 124, the statement is not a branch statement, then in state 128, the method determines if there are any more statements to classify. If, in state 128, there are more statements to classify, then the method returns to state 120. If, in state 128, there are no more statements to classify, then in state 130, the destination location for each of the non-branching statements are recorded in the spreadsheet, the destination for each statement being the statement directly following. Optionally, in state 132, similar types of statements may be grouped together for display in the same box in the flowchart, by recording the same destination in the spreadsheet for each of the grouped statements. In state 134, the spreadsheet is then exported to a drawing program, such as VISIO, a computer program product and registered trademark of Microsoft, Inc.

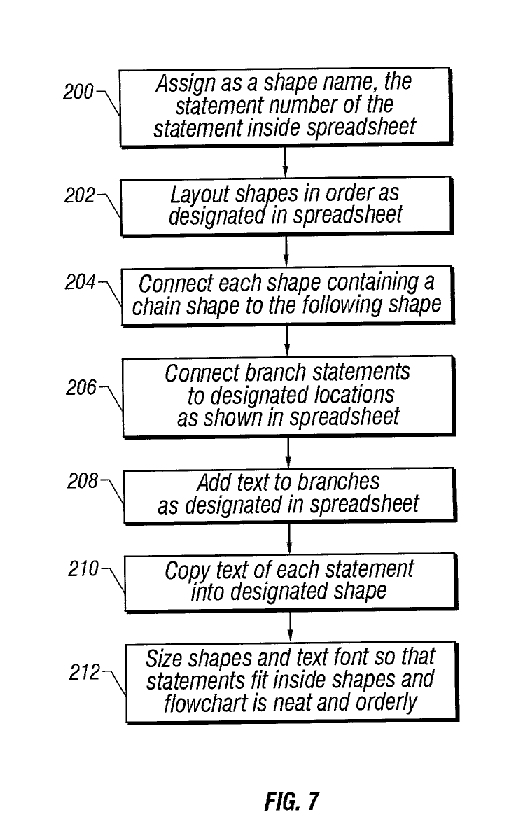

FIG. 7 is a flowchart of a method for generating a flowchart from the information contained in the spreadsheet generated by the method of FIG. 6. In state 200, a shape name is assigned to each shape, the shape name being the statement number contained within the shape. In state 202, each shape is located, or laid out, on the flowchart in the order designated on the spreadsheet, i.e., the shape designated in row 1 followed by the shape in row 2, and so forth. In state 204, each of the shapes designated as containing statement types that are chain statements are connected by an arrow showing the flow from top to bottom. In state 206, each shape containing a branch statement is connected to the destination shape location as instructed on the spreadsheet. In state 208, branch labels are added to the connecting lines from branch statements as instructed on the spreadsheet. In state 210, the text for each statement is inserted into the corresponding shapes. In state, 212, the size of the shapes and font within the shapes are adjusted to provide a neat and orderly flowchart.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method for automatically generating flowcharting instructions from a source code comprising:
loading source code statements into statement records of a data structure, wherein each statement record contains only one of the source code statements;
identifying each branch statement contained in the statement records;
determining one or more branch destinations for each of the branch statements;
storing the one or more branch destinations in one or more destination records of the data structure, wherein the one or more destination records correspond to the statement record of the branch statement; and
identifying a statement type for each statement contained in the statement records.

2. The method of claim 1, further comprising:
maintaining a record management system of statement conventions comprising defined branch statement records and alternative branch statement records, wherein each alternative branch statement record is associated with one defined branch statement record.

3. The method of claim 2, wherein the record management system of statement conventions is selected from a database, a spreadsheet, an array, a set of coded rules in an applications program and combinations thereof.

4. The method of claim 2, further comprising:
finding any alternative branch statements in the statement records; and
replacing each of the found alternative branch statements with the associated defined statement.

5. The method of claim 1, wherein the source code statements are written in a computer programming language selected from FORTRAN, COBOL, C/C++, PASCAL, Visual Basic, and PERL.

6. The method of claim 1, wherein the statement types are selected from decision, input, output, comment, computational, arithmetic, data, type, logic, start, loop, transfer and end.

7. The method of claim 1, wherein the statement types are selected from executable statements, non-executable statements, and comment statements.

8. The method of claim 1, wherein the statement types are selected from chain statements and branch statements.

9. The method of claim 1, further comprising:
maintaining a record management system of statement classifications comprising, for each source code statement type, a statement key, a statement format, destination locations, branch connector labels, a flowchart shape, and combinations thereof.

10. The method of claim 9, wherein the statement key comprises a word, a phrase, punctuation marks, other symbols, and combinations thereof.

11. The method of claim 9, wherein the record management system of statement classifications is selected from a database, a spreadsheet, an array, a set of coded rules in an applications program, and combinations thereof

12. The method of claim 1, wherein the step of identifying a statement type for each of the source code statements contained in the statement records further comprises:
matching a statement key with each of the source code statements, wherein the statement key is associated with one statement type, and wherein the statement key comprises a word, a phrase, punctuation marks, other symbols, and combinations thereof, and
recording in the data structure the statement type for each statement in the statement records.

13. The method of claim 12, further comprising:
assigning a flowchart shape to each statement of the source code, wherein each flowchart shape is associated with the statement type of each statement of the source code; and
storing the assigned flowchart shape in a shape record in the data structure corresponding to the statement record.

14. The method of claim 1, wherein the data structure is selected from a spreadsheet, a database, a linked list, an array and combinations thereof.

15. The method of claim 1, wherein the data structure is created in a computer language selected from COBOL, C, PASCAL and C/C⁺⁺.

16. The method of claim 1, wherein the step of loading source code statements into statement records of a data structure further comprises:
assigning a unique statement number to each statement record; and
storing each unique statement number as a statement number record associated with each statement record in the data structure.

17. The method of claim 1, wherein the step of determining one or more branch destinations further comprises:
parsing each identified branch statement to find the one or more branch destinations designated within the branch statement;
recording the one or more branch destinations into one or more branch destination records contained within the data structure, wherein the branch destination records are associated with the identified branch statement record; and
recording one or more branch labels into one or more branch label records contained within the data structure, wherein the branch label records are associated with the branch destination records.

18. The method of claim 1, further comprising:
exporting the data structure into a drawing program, wherein the data structure contains statement records, statement number records, destination records, text branch label records, and shape records;
laying out shapes as defined in the shape records;
inserting text from the statement records into the shapes;
linking the shapes from the destination records;
sizing the font to fit within the shapes; and
displaying the flowchart.

19. A method for generating a source code text file from a flowchart comprising:
assigning a shape name to each shape appearing on the flowchart, wherein the shape name is a statement number assigned to a first statement within the shape, and wherein each shape name is less than all subsequent shape names;
ending each source code statement within each of the shapes with a statement end character;
writing the statements contained within each shape to an ordered array with the associated shape names;
ordering the array from the least shape name to the highest shape name; and
writing each line of the ordered array to a text file.

20. A computer program product for generating flowcharting instructions from a source code comprising:
loading instructions for loading source code statements into statement records of a data structure, wherein each statement record contains only one of the source code statements;
identifying instructions for identifying each branch statement contained in the statement records;
determining instructions for determining one or more branch destinations for each of the branch statements;
storing instructions for storing the one or more branch destinations in one or more destination records of the data structure, wherein the one or more destination records correspond to the statement record of the branch statement; and
identifying instructions for identifying a statement type for each statement contained in the statement records.
